(19) United States
(12) Patent Application Publication
(10) Pub. No.: US 2016/0364940 A1
(43) Pub. Date: Dec. 15, 2016

(54) CARD DISPENSING MACHINE ANTI-THEFT DEVICE

(71) Applicant: Stephen P. Shoemaker, JR., Redondo Beach, CA (US)

(72) Inventor: Stephen P. Shoemaker, JR., Redondo Beach, CA (US)

(21) Appl. No.: 14/734,301

(22) Filed: Jun. 9, 2015

(51) Int. Cl. G07F 11/00; G07F 11/62; B65D 83/08

(52) U.S. Cl. CPC G07F 11/005; B65D 83/0894; G07F 11/62

(57) ABSTRACT

The present invention is a gift card dispenser for dispensing cards in a larger machine, such as a vending machine or arcade game, where the dispenser includes an electric motor controlled by a computer to perform a single cycle per activation. A stack of cards within the dispenser is arranged to engage a reciprocating pusher device coupled to the electric motor such that the reciprocating pusher extending from a retracted position to an extended position and then returning to the retracting position. A projection on the slider tilts the stack of cards away from the opening of the device, preventing theft of the cards with a hook or wire.

### BACKGROUND

Plastic, cardboard, magnetic, laminated, and many other “gift cards” is have become a kind of currency in which stores, restaurants, bars, arcades, and the like can issue these gift cards with a monetary, ticket, redemption, or other value printed on the card or encoded in the card's magnetic memory. These cards can then be redeemed by customers for merchandise, and can be a valuable source of revenue for the supplier. First, in many cases the gift cards can only be redeemed at the issuer's establishment, ensuring that the money spent on the gift card is used to purchase the issuer's goods, and is an effective way to get customers into their stores. The cards can also have advertisements, store information, and other useful information on the card that the issuer can use to advertise its business. The cards are easy to use, make good gifts, and can be discarded when depleted. For this application, the term “gift card” is to be understood as any card having either a magnetic strip, printed information, or other insignia that is used to store or reflect a designated value, or any other flexible thin card that is used in commerce.

These types of gift cards are becoming prevalent in commerce, and are sold in restaurants, grocery stores, arcades, retail stores, and various other retain locations. However, the cards are usually sold or distributed individually by hand, since there are issues with automated distribution systems for such thin cards. Primarily, these cards can be exceptionally valuable, and machines to distribution these cards are ill-equipped to distribute single cards in an efficient, inexpensive, and reliable manner or are very expensive. The cards in many situations exhibit static electricity that causes the cards to stick together, and their thinness along with their proclivity to stick together make distributing them automatically a challenge. If an automated system accidentally distributed two cards, a retailer could incur a significant loss with each occurrence.

However, many more cards could be distributed and retailers could better use the cards to their advantage if the cards could be made available via an automatic dispensing devices that was reliable and inexpensive. Such devices could be incorporated into vending machines, arcade machines, and dedicated card distributing machines that can be used to exchange cash or electronic purchases in exchange for these gift cards that can be redeemed for in-store purchases. There are dispensing devices that can dispense individual gift cards, but they lack the guarantees of reliability and security that is necessary with gift cards, are very expensive. One issue that is raised is that a vandal or thief can utilize a wire, metal strip, or other elongate member with a hook portion and position the hook behind the stack of cards. By pulling on the elongate member with the hook, cards can be drawn forward through the slot, defeating the single card distribution. With some practice, a thief could quickly position the hook to steal multiple cards, rendering the dispenser ineffective. The present invention is to overcome this issue.

### SUMMARY OF THE INVENTION

The present invention is a theft prevention mechanism on the motor-driven thin card dispenser storing a stack of cards and using a reciprocating pusher mechanism to engages the bottom of the stack of cards. The anti-theft device incorporates a spherical button at the rear of the slide, where the stack of cards sits on the spherical button. The button thus raises the stack of cards so that the front of the lowermost card is above the stop. Any attempt to move a card or cards forward will be thwarted by the stop, including a thief with a hook mechanism. When the dispenser dispenses a card, the slide moves to the rear of the slide and can then push the lowermost card through the slot in its return path. In this manner, only a single card will be distributed and only when the dispenser carries out a full round trip path of the pusher mechanism. In the forward path, the button slips under the stack of cards until it passes completely under the stack, allowing the protrusion to engage the lowermost card. Once the pusher returns, the cards are once again inclined with the lowermost card above the vertical stop, preventing theft or accidental disbursement of more than one card.

These and other benefits will readily be understood when considered in view of the accompanying drawings and the detailed description of the preferred embodiments below.

### BRIEF DESCRIPTION OF THE DRAWINGS

FIG. 1 is an elevated, perspective view of an arcade type game incorporating a single card dispenser of the present invention;

FIG. 2 is an elevated, perspective view of the arcade type game of FIG. 1 exposing the components of the card dispenser;

FIG. 3 is an enlarged, elevated perspective view of the gift card dispenser;

FIGS. 4-6 are side views, partially in cross section, of the operation of the card dispenser; and

FIGS. 7-9 are side views, partially in cross section, of a second embodiment of the card dispenser with an anti-theft device.

### DETAILED DESCRIPTION OF THE PREFERRED EMBODIMENTS

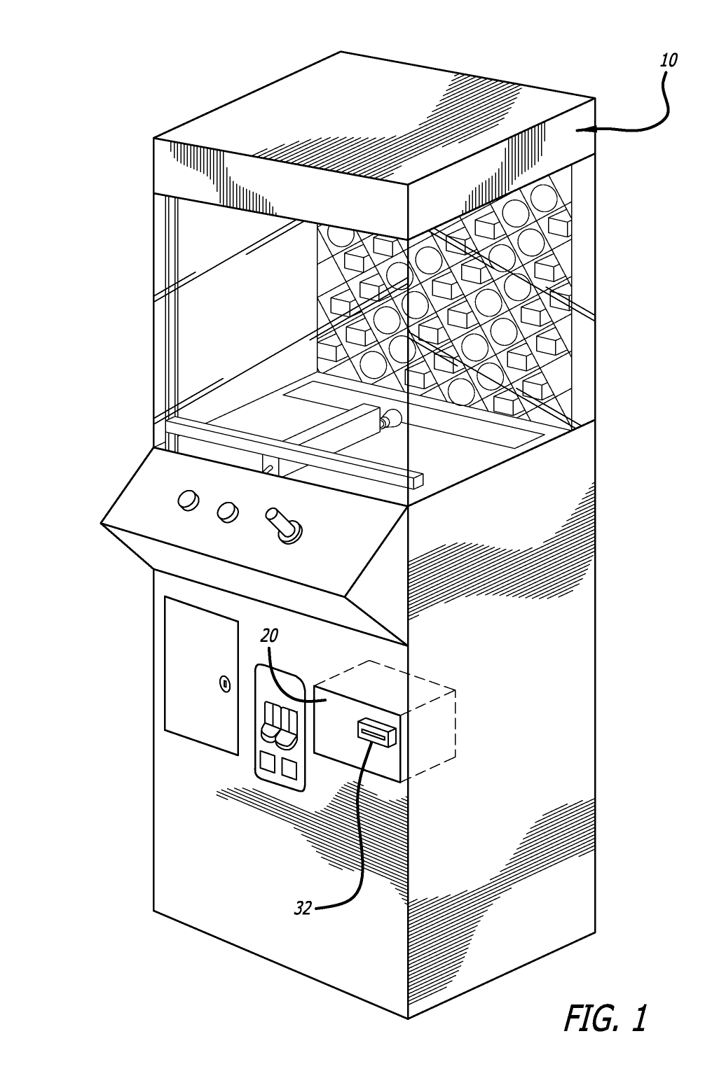

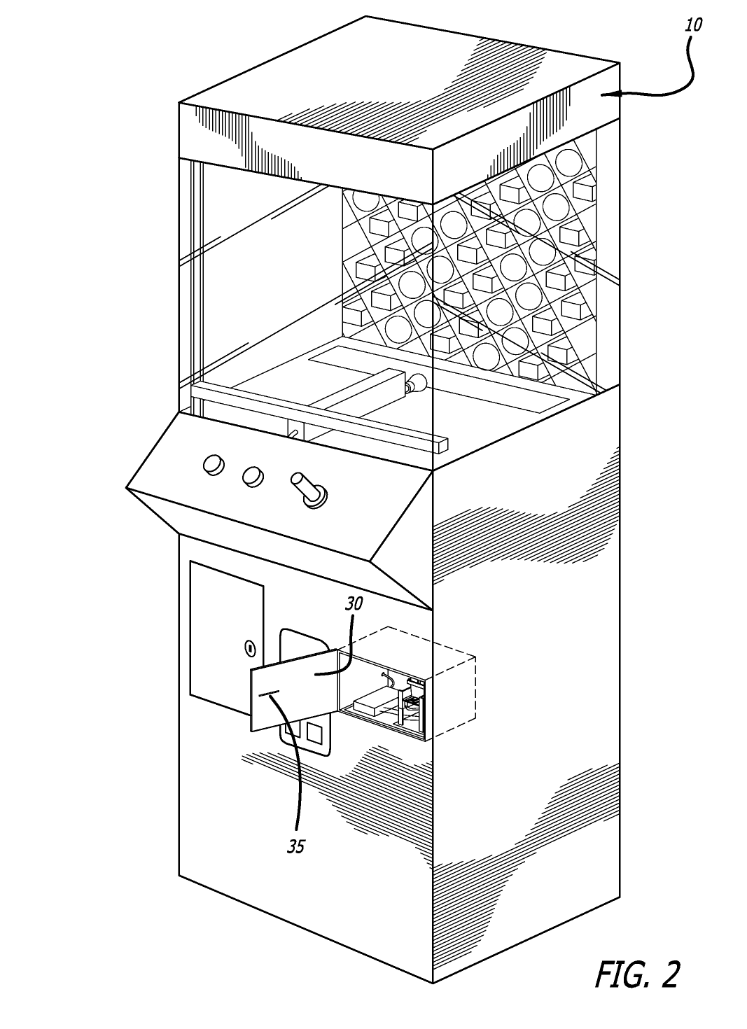

FIG. 1 illustrates a gift card dispensing unit 20 for incorporation into a larger arcade type machine 10 used to dispense gift cards or thin redemption cards and the like. The game machine 10 is intended to be generic, as the unit 20 can be incorporated into any type of larger machine and the game itself plays no part of the present invention. The unit 20 can be incorporated into a vending machine, an arcade game, or a myriad of other types of machines that could be used to dispense single cards to a customer.

In a first preferred embodiment the dispensing unit 20 includes a face plate 30 having a window 35 and preferably a guide 32 for protecting the window from tampering. The faceplate 30 is exposed on a cabinet of the game 10 so that cards may be dispensed through the window 35 after completion of the game play. Gift cards 45 are dispensed by the unit 20 one at a time through the window 35 from a stack of cards 50 stored in the mechanism 10. A standard card 45 is roughly 0.030 of an inch, although other thicknesses and sizes are possible with the present invention. The stack 50 is preferably located adjacent the window 35, so that a horizontal movement of a pusher device 60 displaces a single card 45 through the window 35, or alternately into a collection bin.

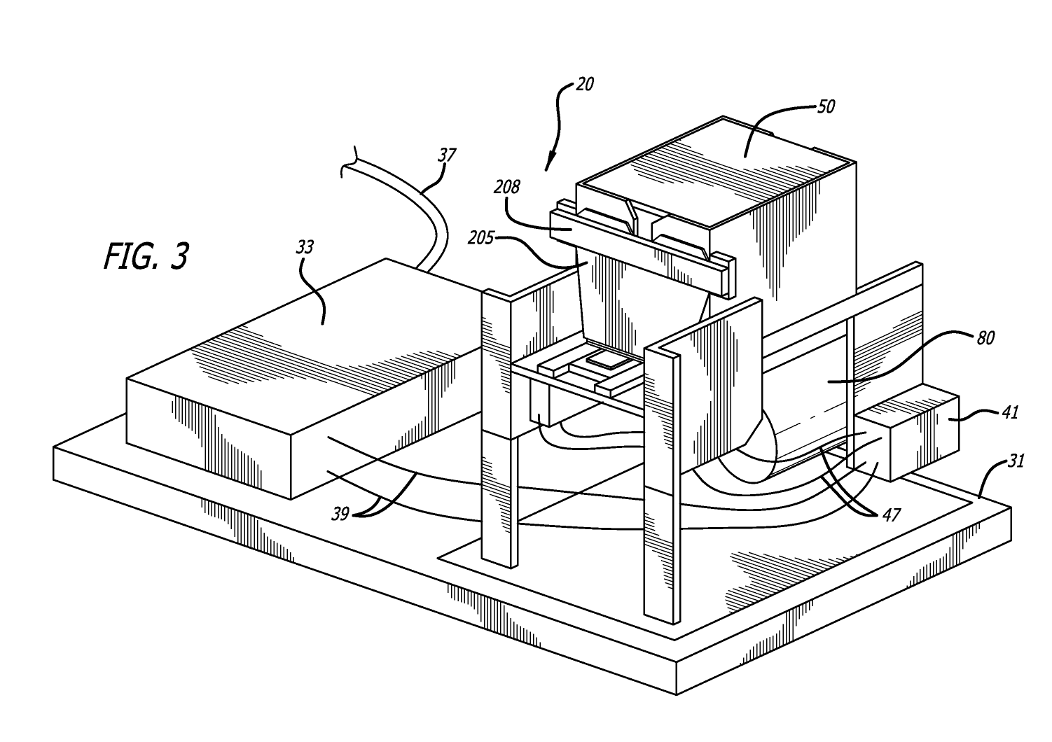

FIG. 3 illustrates the basic components of the card dispenser 20. The unit 20 sits on a base 31, and is powered by an AC power adapter 33 that converts standard 100-240 VAC (Alternating Current) via cable 37 to a 12 VDC (Direct Current). The 12 VDC is connected to a DC motor 80 via wires 47. The DC motor 80 drives a pusher system that extends the lowermost gift card 45 from the stack 50, as explained in greater detail below. A rectangular structure or guide 72 houses a stack of cards 50 above a driver system that pushes a single card from among the stack of cards 50. The guide 72 includes an adjustable faceplate 205 that has an adjustable height set by a pinch bar 208. Fasteners or other means can be used to tighten and release the pinch bar 208, thereby setting the height of the faceplate 205. As explained below, the height of the faceplate 205 above a platform 71 creates an opening or window 74 in the guide that is precisely the width of a single card 45. The dispenser is thus adjustable to a wide range of card thicknesses using the adjustable features of the present invention.

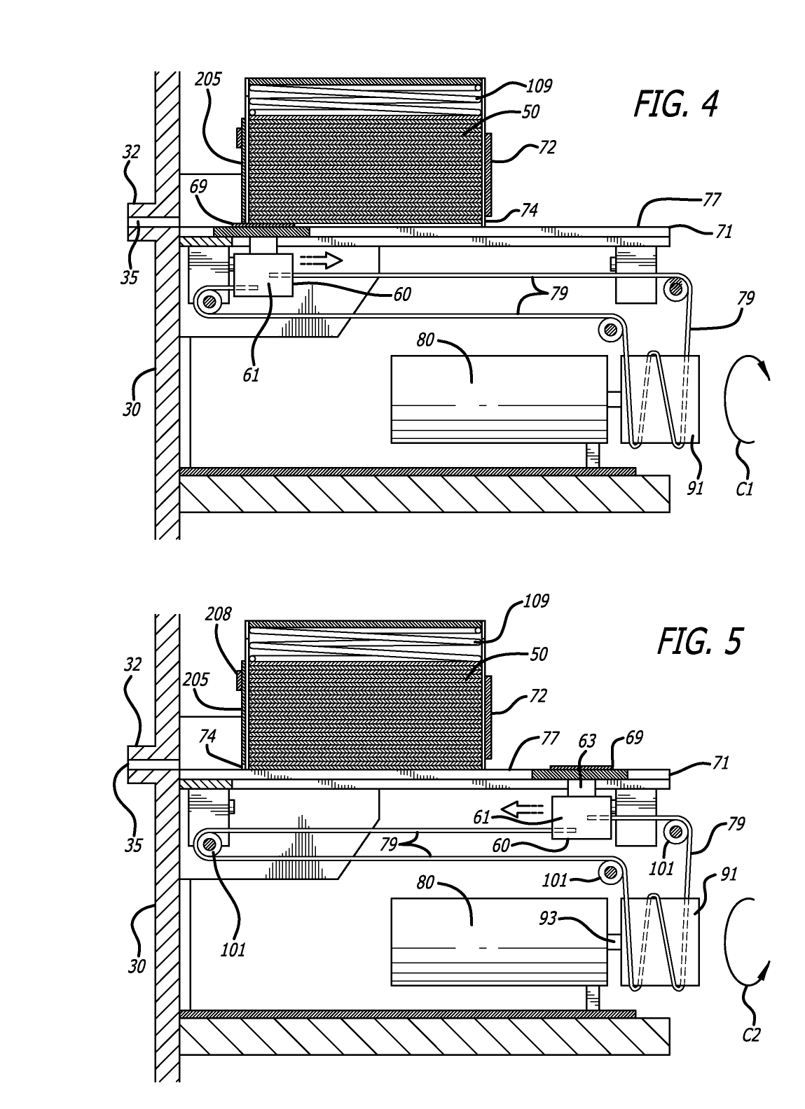

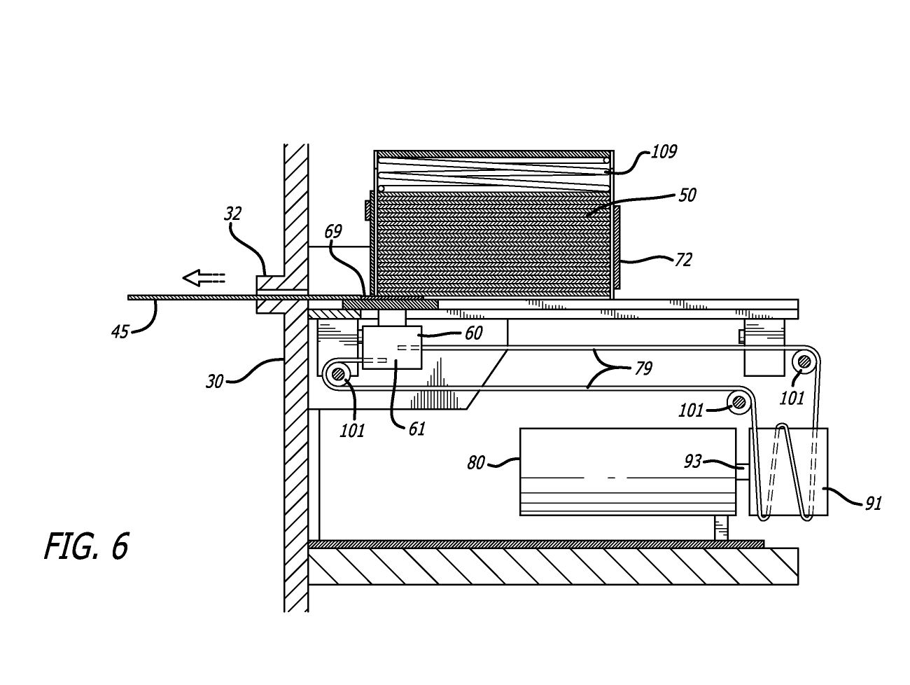

FIGS. 4-6 illustrate the operation of the card dispenser 20 along with the description of the components. A pusher device 60 reciprocates in a horizontal movement from a withdrawn position as shown in FIG. 5 to an extended position in FIG. 6 depending upon the position of the electric motor 80. Initially, the pusher device 60 is at rest below the stack of cards 50 as shown in FIG. 4. The pusher device 60 includes a carriage 61, a neck portion 63, and an elevated ledge 69. The carriage moves below a platform 71 which has a longitudinal slot so that the ledge 69 can move along the upper surface 77 of the platform 71. The carriage 61 is connected to the DC motor by a cable 79 at opposite ends of the carriage such that the cable can pull the carriage in both directions along the platform 71 through pulleys 101. The length of the cable 79 is selected to extend around the shaft 91 of the motor, which is connected to the rotor 93, along the pulleys 101, and connect to opposite ends of the carriage 61. As the rotor 93 of the motor 80 rotates the shaft 91 in the direction of arrow C1 (FIG. 4), the cable 79 moves the carriage 61 of the pusher device 60 from the position shown in FIG. 4 to the position shown in FIG. 5. When the rotor 93 reverses direction and rotates in the direction of arrow C2 (FIG. 5), the shaft 91 moves the cable 79 in the opposite direction so that the carriage 61 is moved to the position shown in FIG. 6. The “home” position for the pusher device 60 is as shown in FIG. 4.

As the pusher device 60 transitions from the withdrawn position of FIG. 4 to the extended position of FIG. 5, on its return trip the ledge 69 engages the stack of cards 50 as they are held in a guide 72. The guide ensures that the cards are neatly oriented for dispersal and that the pusher device 60 will precisely engage exactly the lowermost card 45 in the stack 50. The guide 72 includes an opening 74 adjacent the window 35 that provides for a single card 45 to fit through, as set by the adjustment of the faceplate 205. A spring member 109 applies a compressive force of the stack of cards 50, creating a reliable target for the ledge 69 to push the lowermost card 45 through the opening 74 and out the window 35. As the pusher device 60 transitions from the position in FIG. 5 to the position in FIG. 6, the ledge 69 sliding along the platform 77 engages the lowermost card 45 and pushes the card in the direction of the movement of the carriage 61 as shown. The height of the ledge 69 is selected to be approximately equal to or less than, but no higher than, the height of the card to be distributed. If the height of the ledge 69 is substantially equal to the thickness of the gift cards 45, but not greater than same, then the ledge 69 will engage the lowermost card as the pusher device transitions from the withdrawn position to the extended position and force the lowermost 45 card through the opening 74 in the guide 72 and out the window 25 as shown in FIG. 6. The guide 72, and particularly the size of the opening 74, prevent a second card from being pushed out the window 35 even if static electricity or other forces have caused two adjacent cards to stick together, because the tolerance on the opening 74 only permits a single card from passing through.

The electric motor 80 experiences one cycle each time it is commanded to actuate, extending the pusher device 60 through its full range of motion from its withdrawn position to its extended position, and back to its resting position. As the pusher device 60 withdraws, the stack of cards 50 is reduced by one and the second lowermost card in the stack 50 becomes the new lowermost card. Each cycle of the electric motor 80 pushes exactly the lowermost, and only the lowermost, card from the stack through the opening 74 and through the window 35, which it can be acquired by a customer/player/purchaser. The ledge 69 is preferably tapered or angled on the back side so that on its return path it easily slides under the stack of cards 50 in preparation for pushing the next card through the opening.

To maintain a consistent pressure on the stack of cards 50, it may be necessary to apply a downward force on the uppermost card, ensuring a consistent alignment of the cards at the bottom of the stack. Otherwise, warping or inconsistency in the flatness of the cards could cause the lowermost cards to curl or lift up, thereby preventing the card from passing through the opening 74. By using the spring 109 to constantly press down on the stack 50, any warping or discontinuity in the flatness of the lowermost card is eliminated by the pressure of the downward force, ensuring a flat card and easy passage through the opening 74 and the window 35.

Once the card 45 is delivered to the window 35, the motor 80 reverses its direction to withdraw the pusher device 60 back to its resting position. In an alternate embodiment, the motor (or a second motor) may cause a plate to move over the window 35 to prevent tampering or theft by blocking access to the cards from outside the unit 20. This security measure prevents a person from tampering with the mechanism, or sticking something through the window to steal a card. The blocking plate can be operated by the same cable 79 that controls the pusher device 60, or a second cable can be employed to separately block access to the window 35.

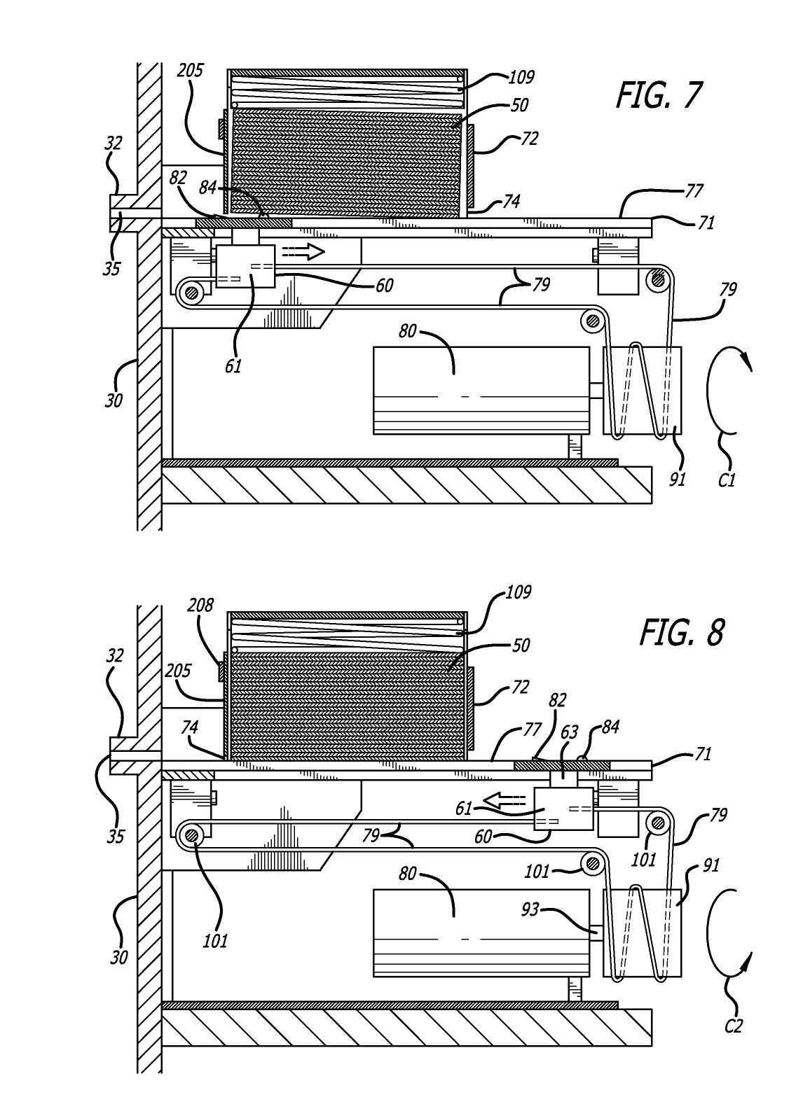

FIGS. 7-9 illustrate a second embodiment of the present invention with an anti-theft mechanism to deter thieves from inserting a thin, elongate hook or wire to defeat the blocking plate. As shown in the figures, the pusher device 60 can include a projection such as, for example, a spherical button 84 on an upper surface adjacent the ledge 69, which can also be a wedge. As shown in FIG. 7, the stack of cards 50 initially rests on the spherical button 84, ensuring that the front of the stack of cards remain above the face plate 205. Any attempt to ensnare and retrieve a card from the outside will be fruitless because the cards are trapped by the face plate 205. The spherical button 84 can also take other shapes, but it is preferable that it has a leading edge that is inclined to prevent getting trapped during the cycle. The button preferably has a smooth, reduced friction surface like a chrome ball or other smooth surface to easily slide underneath the stack of cards 50.

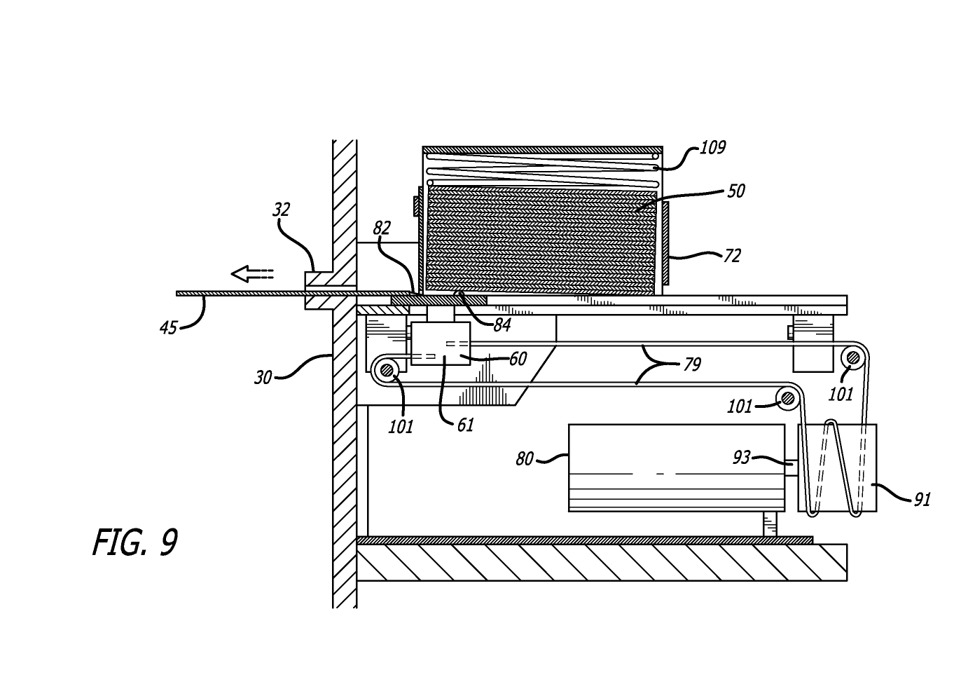

In FIG. 8, the pusher device 60 has completely cleared the stack of cards 50, ready to begin the return trip as it pushes the lowermost card through the slot 74 in the face plate 205. As the pusher device 60 transitions back to the starting position, the wedge shaped ledge 82 engages the stack of cards 50 and the spherical button 84 trails the ledge 82, lifting the remaining cards in the stack to the titled position of FIG. 7. In the tilted position, the lowermost card in the stack is always behind the face plate 205 and above the slot 74, preventing it from being dragged through the slot by a wire or hook. In FIG. 9, the ledge 82 has pushed the bottom card through the slot 35 where it can be retrieved by the patron, while the remaining cards 50 are lifted up by the button 84. In this position, no cards can be “pulled” forward by a tool or the like to steal additional cards through the slot because any forward motion on the cards will only push the cards up higher into the guide 72. In this manner, the dispenser is more secure and more resistant to theft of the valuable cards.

The foregoing description of the card distribution system of the present invention is intended to be merely illustrative and not limiting in the scope of the invention. There are many modifications and alterations that would be readily discernible to one of ordinary skill in the art, and the present invention is intended to encompass all such modifications and alterations. Accordingly, the scope of the present invention should not be limited by anything depicted in the drawings or described herein except where expressly indicated, and the invention should be interpreted in view of the claims below using the terms therein in their ordinary meaning.

1. A card dispenser for dispensing cards comprising:
a electric motor having a shaft that rotates in first and second directions;
a reciprocating pusher device coupled to the electric motor, the reciprocating pusher extending from a retracted position to an extended position and then returning to the retracting position for each single cycle of the electric motor, the reciprocating pusher device including a projection that contacts a lowermost card to lift the lowermost card at a first end by at least a distance equal to a height of the projection;
a stack of cards arranged in a path of the reciprocating pusher device, the stack of cards positioned such that the reciprocating pusher member contacts one and only one card from the stack of cards to remove the one and only one card from the stack of cards; and
a guide for housing the stack of cards including an opening sized to pass only a single card, where the opening is adjacent a window in the dispenser for dispensing the card at least partially outside of the dispenser; and
wherein the projection is in the opening when the reciprocating pusher device is at a home position to block the opening.

2. The card dispenser for dispensing cards of claim 1, wherein the electric motor is connected to a cable, and the cable is connected to the reciprocating pusher, such that the pusher device is moved by tension from the cable when the electric motor performs its single cycle.

3. The card dispenser for dispensing cards of claim 2, wherein the projection is hemispherical.

4. The card dispenser for dispensing cards of claim 3, wherein the projection is adjacent a wedge-shaped element.

5. The card dispenser for dispensing cards of claim 3, wherein the hemispherical projection maintains contact with the lowermost card in the stack of cards until passing underneath the stack of cards.

6. The card dispenser for dispensing cards of claim 1, wherein the dispenser is incorporated into a vending machine.

7. The card dispenser for dispensing cards of claim 1, wherein the dispenser is incorporated into an arcade game.

8. The card dispenser for dispensing cards of claim 1, further comprising an AC power converter for converting a higher voltage to a lower voltage.

9. The card dispenser for dispensing cards of claim 8, further comprising an AC to DC power converter.

10. The card dispenser for dispensing cards of claim 1, further comprising a biasing means for applying a constant pressure to an upper surface of the stack of cards.

11. The card dispenser for dispensing cards of claim 10, wherein the biasing means is a spring.
